(19) United States
(12) Patent Application Publication
(10) Pub. No.: US 2006/0031232 A1
(43) Pub. Date: Feb. 9, 2006

(54) Management tool programs message distribution

(76) Inventors: Keith E. Jahn, Houston, TX (US); Christian Heusbourg, Tomball, TX (US); Michael C. Smith, Sunnyvale, CA (US); Luigi Scinicariello, Magnolia, TX (US); Thomas Smith, Houston, TX (US); Andrew J. Phillips, Roswell, GA (US); Gregory M. Siino, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/837,071

(22) Filed: Apr. 30, 2004

(51) Int. Cl. G06F 7/00

(52) U.S. Cl. 707/100

(57) ABSTRACT

A method and system comprising a first computer system that executes a first management tool program and a second computer system that executes a second management tool program is disclosed. In addition, a management message distribution system is accessible to the first and second computer systems. A message of data generated by the first management tool program may be forwarded to the second management tool program if the second management tool program subscribes to the message. An adapter program may couple the first management tool program to the management message distribution system.

### BACKGROUND

An organization may utilize information technology (IT) to perform a variety of organizational tasks, for example providing data storage, facilitating communication, and automating services. The organization's IT infrastructure of computer systems, networks, databases, and software applications may be responsible for accomplishing these organizational tasks.

Software applications, such as management tools, may configure, maintain, and analyze an organization's IT infrastructure. The management tools may be developed by a plurality of vendors, each vendor exploiting a distinct technology. For example, a first vendor may implement a database management tool in Java, exploiting Java database connectivity (JDBC) connections. A second vendor may implement a database management tool with similar functionality in C, exploiting open database connectivity (ODBC) connections. A holistic view of the organization's IT operations may reveal a multiplicity of loosely-coupled management tools implemented with discrete technologies. Unfortunately, integrating these management tools to provide an end-to-end view of the organization's IT operations may be a time consuming and challenging task. In addition, the ability of the management tools to improve productivity and dynamically allocate resources may be limited by the lack of integration between such tools.

### SUMMARY

The problems noted above may be solved in large part by a method and system of forwarding message between management tools. One of the exemplary embodiments may be a system comprising a first computer system that executes a first management tool program and a second computer system that executes a second management tool program. In addition, a management message distribution system is accessible to the first and second computer systems. A message generated by the first management tool program may be forwarded to the second management tool program if the second management tool program subscribes to the message. An adapter program may couple the first management tool program to the management message distribution system.

### BRIEF DESCRIPTION OF THE DRAWINGS

For a detailed description of some embodiments of the invention, reference will now be made to the accompanying drawings in which:

FIG. 1 illustrates an IT infrastructure in accordance with embodiments of the invention;

FIG. 2 illustrates a system configured in accordance with embodiments of the invention;

FIG. 3 illustrates the systems administered by the management tools of FIG. 2 in accordance with embodiments of the invention;

FIG. 4 illustrates a management procedure in accordance with the embodiments of the invention; and

FIG. 5 illustrates a workflow procedure in accordance with the embodiments of the invention.

### NOTATION AND NOMENCLATURE

Certain terms are used throughout the following description and claims to refer to particular system components. As one skilled in the art will appreciate, various companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to.” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure. In addition, one skilled in the art will understand that the following description has broad application, and the discussion of any embodiment is meant only to be exemplary of that embodiment, and not intended to intimate that the scope of the disclosure is limited to that embodiment.

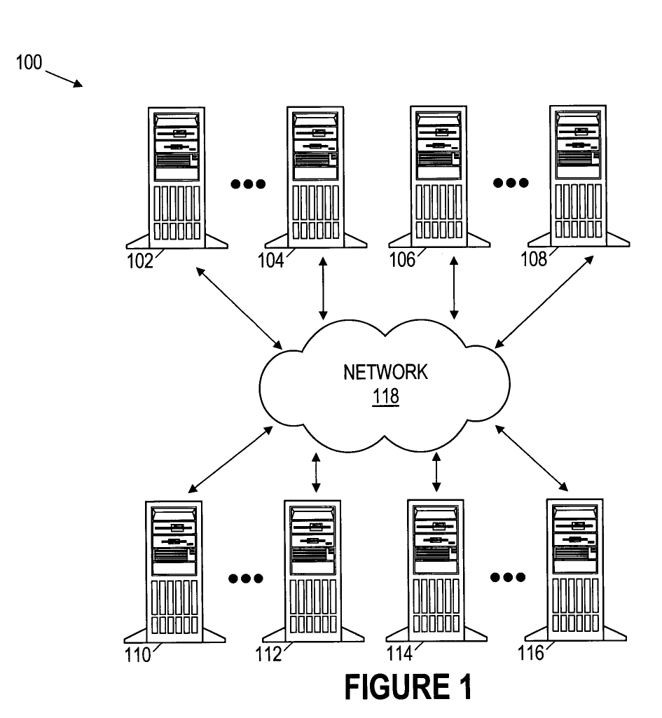

FIG. 1 illustrates an exemplary IT infrastructure 100 in accordance with embodiments of the invention. The IT infrastructure 100 may comprise a plurality of computer systems 102-116 coupled to a network 118. The computer systems 102-116 may be any type of computer system, such as a laptop computer, a personal computer, or stand-alone computer operated as a server. Although not specifically shown, each computer system 102-116 may comprise one or more processors, memories, and network adapters that facilitate the transmission of data between the computer systems 102-116 through the network 118. The network 118 may be any type of computer network, such as a local area network (LAN), wide area network (WAN), or the Internet. Although not specially shown, the network 118 may comprise connectivity devices, for example routers, switches, and hubs, that manage the flow of data. Some of the computer systems 102-116 may function to provide IT services, for example web servers, mail servers, and databases.

The IT infrastructure 100 may logically or physically cross one or more organizational boundaries. For example, the computer systems 102-108 may physically reside at a business partner's location, and the computer systems 110-112 may physically reside at a customer's location. Suppliers, distributors, and vendors may also possess computer systems operating as part of the IT infrastructure 100.

At least some of the computer systems 102-116 may be configured to operate management tool programs, such as performance management programs, configuration and change management programs, inventory and asset management programs, capacity planning programs, and recover and continuity programs. The management tool programs may facilitate the execution of IT operational tasks, for example the provisioning of an organization's resources.

Embodiments of the invention facilitate the exchange of information between management tool programs via a management message distribution system, which may also be referred to as an integration broker. The management message distribution system may be a logical grouping of software components that facilitate the integration of the management tool programs. Each management tool program may be configured to subscribe to and/or publish messages that encapsulate data to a software communications pathway associated with the management message distribution system. Selected transactional messages, for example a message indicating a web-server going offline, may be stored in an operational data store (ODS) that couples to the management message distribution system. A workflow engine that is implemented in software may execute a workflow procedure that utilizes messages published on the management message distribution system to perform one or more high-level business processes.

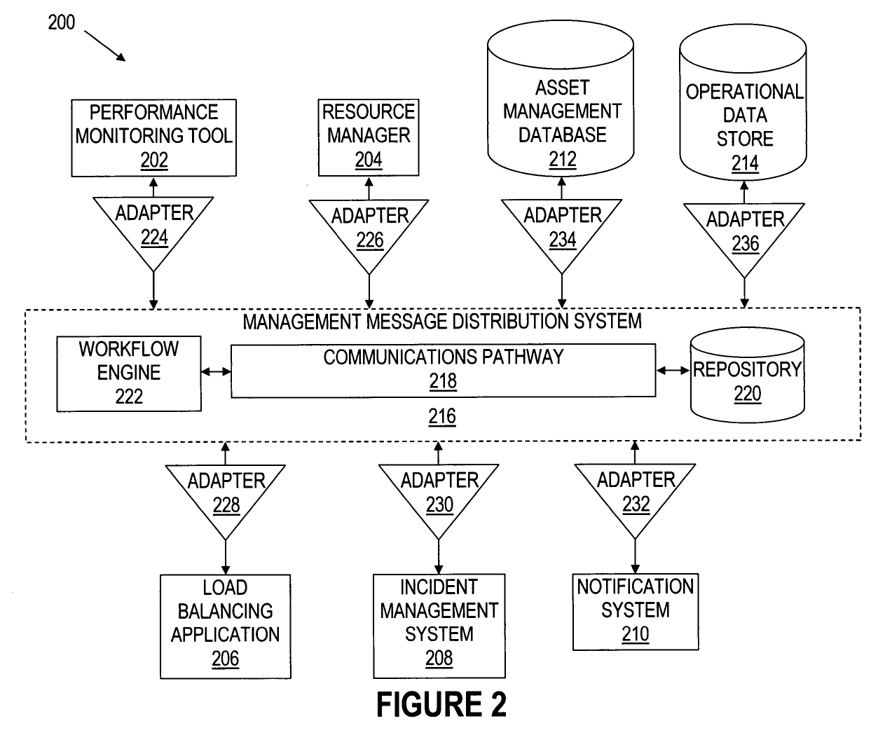

FIG. 2 shows an exemplary system 200 comprising five management tool programs: a performance monitoring program 202, a resource manager program 204, a load balancing application 206, an incident management system program 208, and a notification system program 210. While five management tool programs are illustrated, any number, and any variety of management tool programs may be coupled to a management message distribution system 216. The exemplary five management tool programs 202-210, as well as an asset management database 212 and an operation data store 214, may couple to the management message distribution 216 system via adapters 224-236. The adapters 224-236, programs that translate among various communications protocols, may provide an interface from the attached software application to the management message distribution system 216. Each adapter 224-236 may convert data and perform processing necessary to publish and/or subscribe to messages on the communications pathway 218. Although the management tool programs 202-210, the asset management database 212, and the ODS 214 are shown with a corresponding adapter 224-236, some of these components may be capable of directly interacting with the management message distribution system 216 without the use of an adapter. For example, a management tool program that only publishes messages to the communications pathway 218 may be capable of directly interacting with the management message distribution system 216 via a standard protocol, for example file transfer protocol (FTP) and/or hyper-text transfer protocol (HTTP), without the use of an adapter.

The management message distribution system 216 may comprise a software communications pathway 218, a repository 220, and a software workflow engine 222. Messages that encapsulate data may be published on the communications pathway 218 and delivered to the management tool programs 202-210, the asset management database 212, and the ODS 214. In particular, the management message distribution system 216 may route messages published to the communications pathway 218 to one or more programs that subscribe, where the subscribers may be any component coupled to the management message distribution system 216. All messages published on the communications pathway 218 may utilize a common technology, for example extensible markup language (XML). The adapters 224-232 may be responsible for ensuring that data is converted to and from this exemplary common technology.

The adapters 224-232 may comprise message queues that forward messages to and from the management message distribution system 216. The message queues may be designed to convert messages between supported message formats. In some cases, the adapters 224-232 may directly integrate the management tool programs 202-210, the asset management database 212, and the ODS 214 by establishing a Simple Object Access Protocol (SOAP) web service. SOAP is a protocol designed for exchanging information in a decentralized, distributed environment. The SOAP web service defines the type of data in a message and how a component should process the data. In addition, the web service may comprise a set of encoding rules for expressing instances of application-defined data types and a convention for representing remote procedure calls and responses.

The management message distribution system 216 may also log messages published to the communications pathway 218 in the repository 220. The communications pathway 218 may be implemented via message-oriented middleware (MOM), remote procedure calls (RPC), distributed transaction processing (TP) monitors, or any other technology capable of exchanging data between multiple clients. The communications pathway 218 may recognize different “topics” of messages that are defined via unique data schemas. For example, the performance monitoring program 202 may publish messages utilizing a unique schema to the communications pathway 218. The definition of this schema may be stored in the repository 220, or another suitable location, by the management message distribution system 216. Once a message is published by the performance monitoring tool program 202, the schema of the message is recognized by the management message distribution system 216 and a list of all subscribers of the topic may be obtained from the repository 220, or any other location accessible to the management message distribution system 216. The message may then be forwarded to all subscribers on the list. The subscribers may comprise one or more of the management tool programs 204-210, the asset management database 212, and the ODS 214. In addition, the management message distribution system 216 may convert between schemas when appropriate.

The workflow engine 222 may be based on a programming model, for example .NET, that facilitates the creation and execution of high-level business processes, referred to as workflow procedures. .NET is framework that provides a common language runtime for developing and deploying web-based applications. The .NET framework provides interoperability between managed software components and a variety of developmental tools, such as compilers and debuggers, signed to improve the performance of software applications.

The workflow procedures may utilize messages sent over the communications pathway 218 to integrate the management tool programs 202-210. A user may develop a workflow that is converted and executed by the workflow engine 222 into a workflow procedure.

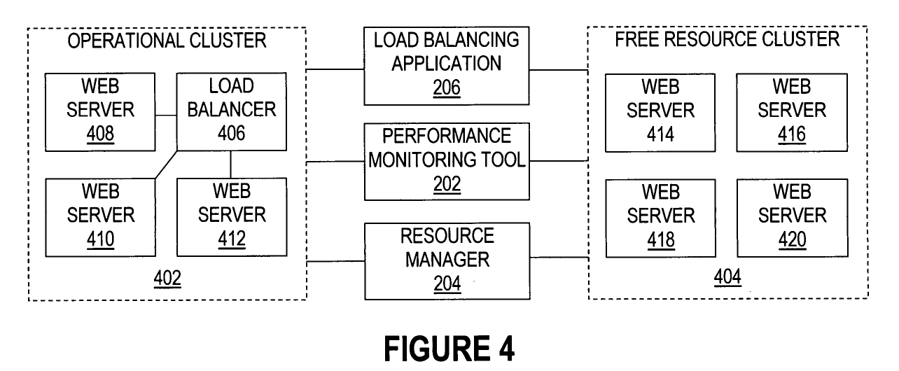

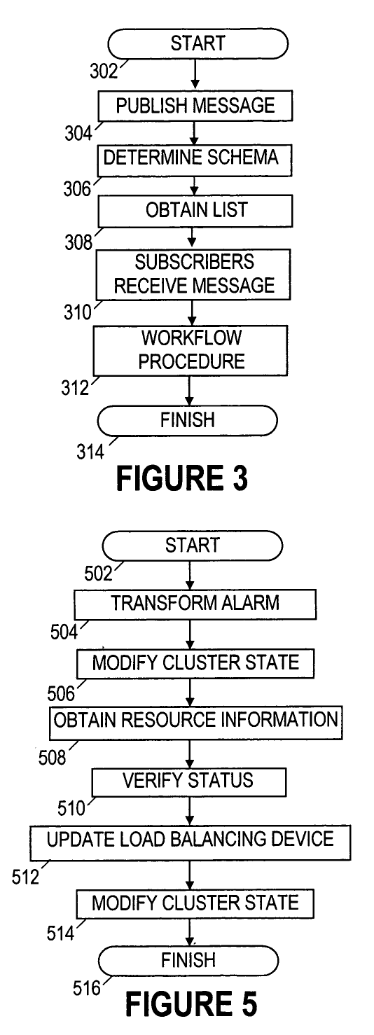

FIG. 3 illustrates an exemplary procedure performed by the management message distribution system 216. The procedure may begin (block 302) with a management tool program publishing a message to the management message distribution system 216 via an adapter 224-232 (block 304). The schema of the published message may be determined, and the message may be associated with a topic (block 306). A list of subscribers of the topic may be obtained (block 308), and the message may be forwarded to the subscribers via the communications pathway 218 (block 310). As previously stated, the definition of the schema and the list of subscribers may be obtained from the repository 220, or another suitable location accessible to the management message distribution system 216. A workflow procedure may be executed by the workflow engine 222 (block 312), and the procedure may finish (block 314).

In order to illustrate interaction between management tool programs and the management message distribution system in accordance with embodiments of the inventions, an exemplary cluster of web servers, and supporting management tool programs, are described below in FIG. 4. The system of FIG. 4 is only one example of a managed system in which the management tool programs may be coupled to a management message distribution system.

Referring now to FIG. 4, an exemplary set of systems that could be administered by the management tool programs 202-206 are shown in accordance with exemplary embodiments of the invention. As shown, the performance monitoring tool program 202, the resource manager program 204, and the load balancing application 206 may administer an operational cluster 402 and a free resource cluster 404 of web servers. The operational cluster 402 may comprise a load balancer 406 connected to one or more web servers 408-412. The load balancer 406 may comprise any type of load balancing device, for example a load-balancing network switch or router. The free resource cluster 404 may comprise web servers 414-420 that may be configured into the operational cluster 402 by a workflow procedure depending upon the load on the operational web servers 408-412. For example, if the load on the operational web servers 408-412 is above a defined threshold, a workflow procedure may select one or more of the free resource web servers 414-420 from the free resource cluster 404 and configure the selected web servers into the operational cluster 402. The one or more free resource web servers 414-420 being configured into the operational cluster 402 may also need to be registered with the load balancer 406 by the workflow procedure to ensure proper operation. The operational cluster 402 and the free resource cluster 404 may represent one or more of the computer systems in the IT infrastructure 100 (FIG. 1).

Referring again to FIG. 3, the exemplary procedure performed by the management message distribution system 216 may be applied to the system of FIG. 4 to manage the cluster of web servers. The procedure may start (block 302) with the performance monitoring tool program 202 publishing an alarm message to the communications pathway 218 under a specified topic when a threshold level of load is detected on the operational cluster 402 (block 304). The schema of the alarm message may be determined by the management message distribution system (block 306), a list of subscribers obtained (block 308), and the subscribers of topic, namely the incident management system program 208, the notification system program 210, and the operation data store 214, may receive the alarm (block 310). A workflow procedure may be executed by the workflow engine 222 after recognition of the alarm message (block 312), and the procedure may end (block 314). Although not specifically shown, once the subscribers of the topic receive the alarm (block 310), each subscriber may perform functions associated with their respective management tool program. For example, when the notification system program 210 receives the alarm, a notification of the alarm may be sent to selected individuals via email, telephone, or a pager. In addition, the incident management system program 208 may create an incident ticket for the condition stated in the alarm for IT personnel.

FIG. 5 illustrates an exemplary workflow procedure executed by the workflow engine 222 and triggered by the publishing of the alarm message by the performance monitoring tool program 202 for the exemplary system of FIG. 4. The exemplary procedure may start (block 502) and transform the alarm message published by the performance monitoring tool program 202 (block 504). This transformation may be a conversion of the schema of the alarm message to a schema utilized by the workflow engine 222. The state of the operational cluster 402 may be changed by the workflow engine 222 in the asset management database 212 to reflect the execution of the workflow procedure (block 506). For example, the state may be changed from “live” to “provisioning.” The workflow engine 222 may send a message to the resource manager 204, triggering the resource manager 204 to obtain resource information from the free resource cluster 404 matching the type of alarm published by the performance monitoring tool 202 (block 508). For example, if the performance monitoring tool 202 published an alarm indicative of a high load on the operational cluster 402, one or more web servers 414-420 belonging to the free resource cluster 404 may be identified. Identification may be accomplished by the workflow engine 222 querying the asset management database 212 for a server name, an Internet protocol (IP) address, and the name of any load balancing device associated with the operational cluster 402. Once the resource information has been obtained (block 508), the status of the resource may be verified by the workflow engine 222 (block 510), and the identified load balancing device may be updated to incorporate the new resource (block 512). The state of the operational cluster 302 may be modified in the asset management database 212 back to its original state (block 514), and the workflow procedure may finish (block 516). Although not specifically shown, transactional data during any step of the workflow procedure may be logged to the operation data store 214. In addition, error-handling procedures may be included to detect and resolve errors during the workflow procedure.

After completion of the exemplary workflow procedure, the operational data store 214 may store several entries of transactional data. The operational data store 214 may comprise an application layer that formats and displays the transactional data to a user. The transactional data may be analyzed by the user to improve the productivity of the organization employing embodiments of the invention. For example, if the operational data store 214 contains information revealing high demand on the operational cluster 402 every Monday, an IT administrator may respond to future expected demand on the operational cluster 402 by configuring one or more additional web servers on Monday morning or by incorporating the expected demand into a management tool that automatically provisions the web servers. Thus, embodiments of the invention increase an organization's capacity for knowledge management and reveal the potential productivity gains accompanying the more efficient use of the organization's resources.

Furthermore, the transactional data stored in the operational data store 214 may be aggregated with other more static data, such as the cost of a component or service, to build information stores that drive fact-based business decision-making. For example, transactional data generated by the management tools may be aggregated with the more static cost data to expose IT demand behaviors from a business perspective. This consumption oriented reporting may facilitate the transition of an IT financial structure from a primarily fixed model to a more variable model that exposes the cost of a given IT service and the associated consumption by the business. This capability may provide the business with a set of gauges and controls on IT spending.

Although exemplary embodiments utilized a set five management tools, additional management tools may be incorporated from different functional areas of an organization. For example, a purchasing tool may subscribe to messages published on the message bus by the performance monitoring tool program. If a threshold level of alarms is exceeded, the performance monitoring tool program may publish a message that is subscribed to by a purchasing tool program. The purchasing tool program may utilize a list of expenditures approved by an organization to verify and place an order for an additional web server with a supplier.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A management system, comprising:
a first computer system that executes a first management tool program;
a second computer system that executes a second management tool program;
a management message distribution system accessible to the first and second computer systems; and
an adapter program that couples the first management tool program to the management message distribution system;
wherein the management message distribution system forwards a message generated by the first management tool program to the second management tool program if the second management tool program subscribes to the message.

2. The system of claim 1 wherein the adapter program converts data generated by the first and second management tool programs to a protocol supported by the management message distribution system.

3. The system of claim 1 wherein management message distribution system comprises a software communications pathway that routes the message from the first management tool program to the second management tool program.

4. The system of claim 3 wherein the software communications pathway is implemented with a technology selected from the group consisting of one or more of message-oriented middleware (MOM), remote procedure calls (RPC), and distributed transaction processing (TP) monitors.

5. The system of claim 1 further comprising an operational data store that logs selected messages forwarded by the management message distribution system.

6. The system of claim 5 wherein the operational data store comprises an application layer that formats and displays the selected messages to a user.

7. The system of claim 1 wherein the management message distribution system comprises a workflow engine application that executes a workflow procedure when a selected message is received from the first management tool program.

8. The system of claim 1 wherein the message comprises an extensible markup language (XML) document.

9. A computer readable medium storing a program that, when executed by a processor of a computer, performs a method comprising:
receiving a management message from a first management tool program;
obtaining a list of a plurality of second management tool programs that subscribe to the message; and
forwarding the management message to selected second management tool programs indicated on the list.

10. The computer readable medium of claim 9 further comprising determining the schema of the message.

11. The computer readable medium of claim 9 further comprising converting the management message from a first schema utilized by the first management tool program to a second schema utilized by the plurality of second management tool programs.

12. The computer readable medium of claim 9 further comprising converting data from a protocol supported by the first management tool program to a protocol utilized by the plurality of second management tool programs.

13. The computer readable medium of claim 9 further comprising storing the management message to an operational data store.

14. A system, comprising:
a first means for executing programs that stores a first processor-based means for managing an IT infrastructure;
a second means for executing programs that stores a second processor-based means for managing an IT infrastructure;
a processor-based means for distributing messages between the first and second processor-based means for managing an IT infrastructure, the processor-based means for distributing accessible to the first and second processor-based means for executing programs; and
a processor-based means for coupling the first and second processor-bases means for managing an IT infrastructure to the means for distributing messages.

15. The system of claim 14 wherein the processor-based means for distributing message comprises a means for distributing extensible markup language (XML) documents.

16. The system of claim 14 further comprising a means for storing selected messages distributed by the means for distributing messages.

17. The system of claim 14 further comprising a processor based means for executing a workflow procedure when a selected message is distributed by the processor-based means distributing messages.
